(19) United States
(12) Patent Application Publication
(10) Pub. No.: US 2007/0063122 A1
(43) Pub. Date: Mar. 22, 2007

(54) Aircraft seat track system, apparatus and method

(76) Inventors: Alan David Bowd, Ferndale, WA (US); Robert Cox, Bellingham, WA (US); Mike Leenhouts, Bellingham, WA (US)

Correspondence Address: Hughes Law Firm, PLLC, Suite 302, 4164 Meridian Street, Bellingham, WA, 98226-5583, US

(21) Appl. No.: 11/335,484

(22) Filed: Jan. 19, 2006

Related U.S. Application Data
(60) Provisional application No. 60/645,623, filed on Jan. 21, 2005.

(51) Int. Cl. F16M 13/00

(52) U.S. Cl. 248/429

(57) ABSTRACT

A seat track system adapted for use in aircraft or other modes of transportation. There is at least one seat track at a floor level, the seat track having access to a channel with access regions and retaining regions. One or more seat track attach fittings are provided, each of which comprises a base section and a retaining section. The base section has a positioning section that fits into the access region of the track and also a load reacting section at the retaining region. A retaining component is positioned in the channel in the track and moved from a non-retaining position to a retaining position where it is a load bearing relationship with the load reacting section of the base section.

### RELATED APPLICATIONS

This application claims priority benefit of U.S. Ser. No. 60/645,623, filed Jan. 21, 2005.

### BACKGROUND OF THE INVENTION

a) Field of the Invention

The present invention relates to a system for securing various articles and objects that are being transported, and more specifically a seat track system adapted for use in the aircraft industry or other modes of transportation, and more particularly to the system, seat track attach mechanisms and methods by which various components of the airplane can be secured to seat tracks in the airplane fuselage or other transportation vehicles.

b) Background Art

For a number of decades in the aircraft industry, the conventional way to attach seats and other components in the fuselage of the aircraft to the floor level of the aircraft is to utilize seat tracks which extend lengthwise at or adjacent to the floor level of the fuselage. In recent decades, the configuration of the connecting portion of the track has become in large part standardized. The track connecting structure comprises a floor, sidewalls and inwardly extending edge portions that define a channel extending the length of the track. Pairs of lugs extend laterally inwardly from the upper edges of the side walls, and the lugs are separated along the lengthwise axis of the track by circularly shaped recessed portions which define positioning locations along the length of the track. These positioning locations are spaced at one inch intervals along the length of the track.

In order to attach the seats and other components that are to be secured in the fuselage, there are provided seat track attach fittings that are secured in the track, and these have an attaching means, such as a upwardly facing socket to receive a bolt that connects the seat or other component that is to be secured to the fitting which in turn is secured to the track.

Seat track fittings are typically installed into the seat tracks by lowering these into the seat track channel and then moving the fitting one half an inch along the axis of the seat track to lock the fitting underneath the seat track lugs. In a common configuration of the seat track fittings, a locking washer or sheer boss is then used to prevent the seat track attach fitting from moving in either a transverse horizontal direction or in a forward to rear direction, thus fully restraining the fitting. With this type of fitting, the attaching location at which a bolt or other fastener is to be connected to the fitting is located at the location of the pair of lugs that extend over the channel of the track.

For various reasons, it is often desirable that the seat track attachment fitting have an upper surface which is flush with the surrounding floor. Further, in some instances there are advantages in being able to make a connection to the seat track attach fitting which is not at the location of the lugs, but at a connecting location which is positioned along a lengthwise axis between two adjacent longitudinally spaced pair of lugs.

The present invention is directed toward providing solutions to meet these needs.

### BRIEF DESCRIPTION OF THE DRAWINGS

FIG. 1 is an isometric view illustrating a prior art seat track, and components (or portions of components) in the fuselage of the airplane which would be secured to the seat track, and showing only schematically a seat track attach fitting that would be utilized to make the connection to the seat track;

FIG. 2 is a top plan view of the airplane components that are shown partially in the FIG. 1, where those components are drawn more completely and shown in a position to be attached to three seat tracks;

FIG. 3 is a sectional view taken along line 3-3 of FIG. 2;

FIG. 4 is a sectional view of a commonly used prior art seat track, with this sectional view being taken along a transverse plane passing through a pair of retaining lugs of the seat track;

FIG. 5 is a top plan view of a portion of the seat track;

FIGS. 6-9 are four sequential views illustrating somewhat schematically the basic components of a type of prior art seat track attach mechanism that is commonly used in the aircraft industry, with this sequence of drawings illustrating the manner in which the prior art seat track attach fitting is placed and then secured in its operating position in the seat track;

FIG. 10A is an isometric view of a base member of a first embodiment of a seat track attach fitting of the present invention;

FIG. 10B is a top plan view of the base section shown in FIG. 10A;

FIG. 10C is a side elevational view of the seat track attach fitting of FIGS. 10A and 10B;

FIG. 10D is a sectional view taken along line 10D-10D of FIG. 10B;

FIG. 11A is an isometric view of a retaining member of a first embodiment of the present invention;

FIG. 11B is a top plan view of the retaining member of FIG. 11A;

FIG. 11C is a side elevational view of the retaining member shown in FIGS. 11A and 11B;

FIG. 11D is a sectional view taken along line 11D-11D of FIG. 11B;

FIG. 12 is an isometric view showing the seat track attach fitting of the first embodiment positioned in a seat track in an intermediate operating position;

FIG. 13 is a top plan view of FIG. 12;

FIG. 14 is an isometric view similar to FIG. 12, but showing the seat track attach fitting in its secured position in the seat track;

FIG. 15 is a top plan view of FIG. 14;

FIG. 15A, 15B, and 15C are sectional views taken along lines 15A, 15B and 15C of FIG. 15;

FIG. 16 is an isometric view of the first embodiment of the seat track attach fitting shown in its preinstalled position (illustrated in FIG. 12) but for purposes of illustration not showing the seat track;

FIG. 17 is an isometric view similar to FIG. 16, and showing the seat track attachment fitting in the secured position of FIG. 14, but for purposes of illustration not showing the seat track;

FIGS. 18, 19, and 20 illustrate a base member of second, third, and fourth embodiments, respectively, of the present invention;

FIG. 21 is an isometric view of a retaining member of the second embodiment which is used in conjunction with the base member of FIG. 18 of the second embodiment;

FIG. 22 is an isometric view of a retaining member which is used in conjunction with the base member of FIG. 19 of the third embodiment;

FIG. 23 is an isometric view of a retaining member of a fifth embodiment of the present invention;

FIG. 24 is an isometric view of the second embodiment of the present invention where there is shown the base section of FIG. 18 and two of the retaining members of FIG. 21, with the base member and the two retaining members being joined in an operating position;

FIG. 25 is an isometric view of the third embodiment, showing the base section of FIG. 19 connected to the retaining member of FIG. 22, in a manner that these are in the operating position; and

FIG. 26 is an isometric view of the fourth embodiment combining the base section of FIG. 20 with two other retaining members as shown in FIG. 22.

FIG. 27 is an isometric view of a base section of a sixth embodiment.

FIGS. 28, 29 and 30 are a top view, side view, and end view of the base section of FIG. 27.

### EMBODIMENTS OF THE PRESENT INVENTION

It is believed that a better understanding of the present invention will be obtained by first discussing the overall arrangement and functions of the seat tracks and seat track attach-fittings that are commonly used in an airplane, second discussing in more detail the configuration of the seat tracks commonly used in today's aircraft, and third the basic arrangement of some of seat track attach fittings commonly used in the prior art. This will then be followed by a description of the embodiments of the seat track attach fittings, an embodiment of the method of the present invention, and the combination of these embodiments with the seat track.

a) The Overall System

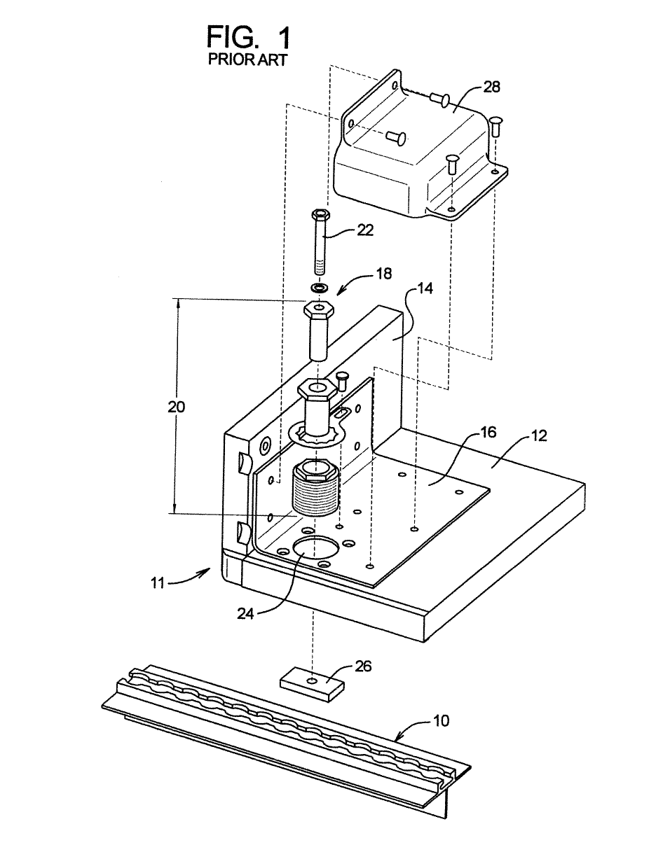

To described the overall prior art system of how seats and other components are secure to the seat tracks, reference will be made to FIGS. 1-3, and initially to the exploded isometric view of FIG. 1. There is shown in FIG. 1 a seat track 10 and a section of a floor and wall structure 11 that would be positioned within the fuselage of an airplane. Only a small corner section of the floor panel 12 is shown in FIG. 1, and also a small portion of the wall section 14 that extends upwardly from an edge of the floor panel 12. A right angle brace 16 connects to both the floor panel 12 and the wall section 14.

There is a prior art fastener 18 comprising a sleeve member, and bushings (collectively designated 20) and a single bolt 22 extending downwardly through these components 22. In its attaching position, the fastener 18 is located in an opening 24 through the floor panel 12 and the right angle bracing member 16, and the bolt 22 extends through the sleeve member and bushings 20 to connect to a seat track attach fitting which is shown only schematically at 26. The lower end of the bolt 22 is connected to a female threaded opening in the seat track attach fitting 26 that is in turn secured to the seat track 10. A cover 28 is attached to the right angle bracing member 16 to conceal that area of the fastener 18 from the interior of the aircraft fuselage.

FIG. 2 is a top plan view showing the same arrangement of FIG. 1, but with the floor panel 12 extending over a greater area so that it extends over three seat tracks 10, and there are four fastening locations at corners of the panel 12. FIG. 3 is a sectional view taken along line 3-3 of FIG. 2.

It is to be understood that all of the components 10-28 as described above are, or may be, already existing in the prior art.

b) The Prior Art Seat Track

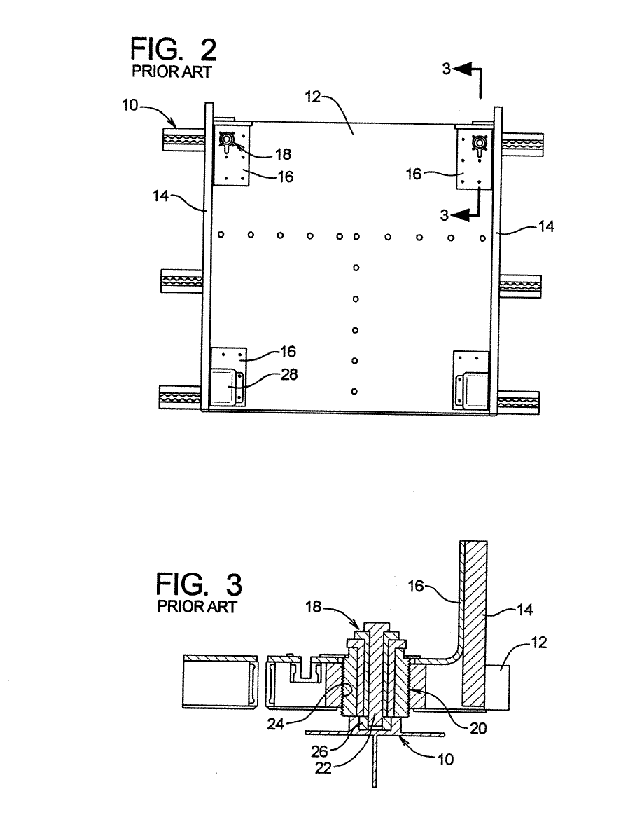

There will now be given a more detailed description of the prior art seat track 10 with which the seat track attach assembly of the embodiments of the present invention can be utilized. This will be done primarily with reference to FIGS. 4 and 5.

The seat track 10 is made (or can be made) as a unitary integral structure, and in terms of function, it can be considered to comprise a track base structure 30 and a track connecting structure 32. The track connecting structure 32 has an interior channel 34 which is defined by a floor 36 having an upwardly facing floor surface 38, vertical side walls 40, with each having a laterally inwardly facing surface 42 and retaining edge portions 44 extending inwardly from upper edge portions of the side walls 40.

In the following description, the seat track 10 will be considered as having a longitudinal center axis 46 (also referred to as the track axis), a horizontally aligned transverse axis 48 perpendicular to the longitudinal axis 46, and a vertical axis 50 (See FIGS. 4 and 5).

The term “seat track” is commonly used in the aircraft art to denote a mounting track which is used not only for seats, but also to hold down cargo and other items or components that are present in the fuselage of an airplane, and in this present application the term “seat track” is to be used in its broader sense.

The seat track 10 has a plurality of longitudinally spaced access regions 52 which are provided at evenly spaced intervals along the longitudinal axis 46. Each access region 52 is provided as an inner circular recessed edge surfaces 53, formed in the two edge portions 44. These are arranged in oppositely positioned pairs, as positioning surface portions 53 arranged matching pairs that define a circular space which can be designated as a positioning region 54.

The access regions 52 are sized and spaced longitudinally from one another a sufficient distance so that each adjacent longitudinally aligned pair of edge portion 44 forms a retaining region 56 which is in the form of two track retaining members 57, also called lugs 57. The track lugs 57 of the two retaining edge portions 44 are positioned oppositely from one another in transversely aligned pairs so that the pairs of track lugs 57 (track retaining members 57) that are aligned transversely from (and spaced from) one another form center gaps 58 at regularly spaced intervals along the longitudinal axis 46.

For purposes of description, the seat track 10 will be considered as having three levels at different height locations. First, there is an upper surface level 60 at the upper surface of the two side walls 40 and the retaining edge portion 44. There is an intermediate level 62 which is at the lower inner edge 63 of each pair of two lugs 56. Then there is a lower surface level 64 at the level of the upwardly facing surface 38 of the floor 36.

There is a channel width dimension 66 that is measured between the outermost surface portions of the inwardly facing inside surfaces 42 of the side walls 40, and there is a gap width dimension 68, measured between the two inwardly facing surfaces 70 of the two track lugs 56 of each pair. Finally, there is a recess width dimension 72 which is measured transversely between the two outermost surface portions 74 of the vertical edge surfaces 53 of the side recessed regions 52. Also, there is a pitch dimension 76 that is measured between center points of adjacent positioning regions 54.

This particular configuration of the track structure 34 of the seat tracks 10 has been in existence for a good many years, and it has been adopted by most all of the aircraft industry as a standard. However, the base structure 30 of the seat track 10 may vary substantially in various designs of seat tracks. As will become more apparent as the embodiments of the present invention are described, it is the configuration of the track connecting structure 32 that is significant in the embodiments of the present invention.

c) A Prior Art Seat Track Fitting

There will now be a description of the basic components of a type of a seat track attach fitting 80 which has been (and is) commonly used in the aircraft industry, and this will be described with reference to FIGS. 6-9 which are sequential drawings which show not only the configuration of this fitting 80, but also the manner of which it is installed in its operating position.

The prior art seat track attach fitting 80 comprises a base section 82 and a locating member 84 which is in this embodiment has a disk like configuration and is called a washer 84 having a center opening 85. The base section 82 comprises a base plate 86 having a generally rectangular configuration and having an upper surface 88 and a positioning stub 90. At opposite first and second end portions of the base plate 86, there are, respectively, a first and second pair of laterally and oppositely extending retaining members 92. Located at the first end portion of the base plate 86 is an upwardly positioned connecting block 94 which is integral with or fixedly connected to, the connecting block 4, and which has an upwardly directed threaded connecting opening 96.

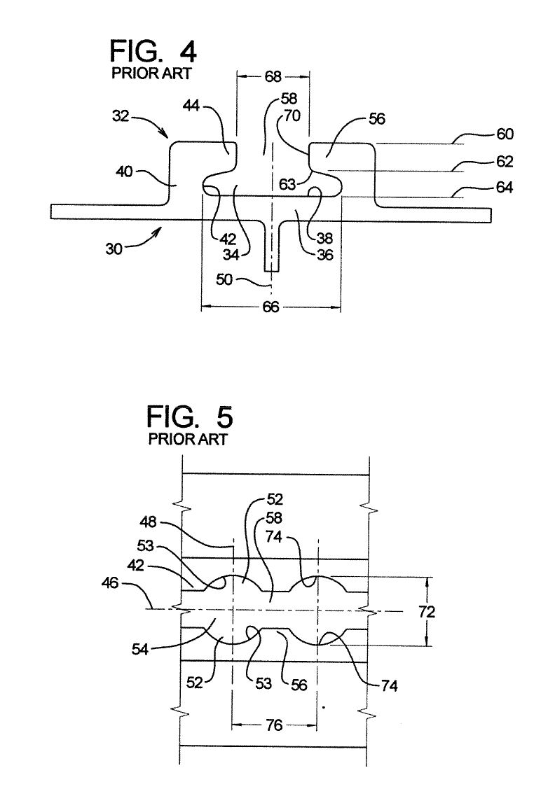

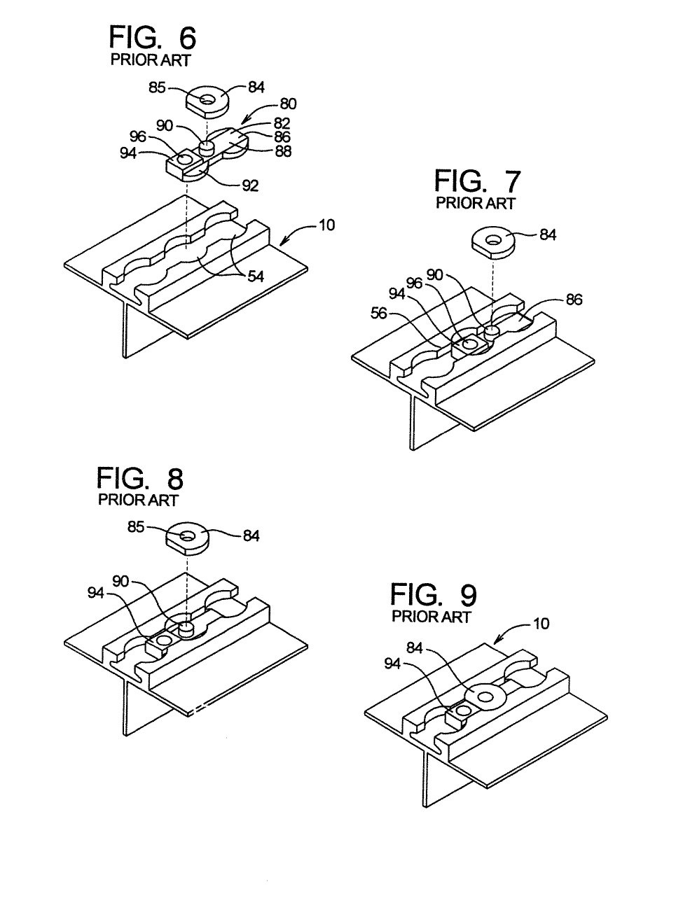

To install the seat track attach fifting 80, the base section 82 is aligned so that the two pair of first and second retaining members 92 are aligned with two of the positioning regions 54 of the seat track 10. Then the base section 82 is lowered so that the base section 82 is located in the position shown in FIG. 7. Then the base section 82 is moved forwardly one half of the pitch distance between two adjacent retaining regions 54 (i.e. 0.5 inch) so that the two pair of retaining members 92 are located under the retaining members (track lugs 56) of the seat track 10, as shown in FIG. 8.

Then, as shown in FIG. 8, the locating washer 84 is aligned with the positioning stub 90 and lowered into place as indicated by the arrow in FIG. 8 so that it fits into the positioning region 54, as shown in FIG. 9, with the stub 90 fitting into the opening 85 of the locating washer 84. Then the locating washer 84 may be fixed in its position at FIG. 9 in some manner, or is held in place when the attachment of the load or object to the seat track attach fitting is made.

It will be noted that the connecting block 94 is located between a pair of opposed seat track lugs 56, and the first pair of retaining members are beneath that pair of lugs 56. The connection from an object in the fuselage of the aircraft (e.g. a seat, a galley fixture, storage structure, etc.) would be attached to the seat track 10 by having a bolt being threaded into the connecting opening 96 of the connecting block 94. The locating washer 84 reacts the forward to rear loads and lateral loads from the object that is secured to the seat track housing thereto into the adjacent retaining edge portions 44 of the track 10. The vertical loads that are transmitted into the seat track attached fitting 80 are reacted through the retaining members 92 into the lugs 56 and into the seat track structure.

It will be noted that in the configuration of this prior art seat track attach fitting 80, that the upper surfaces of the components of the seat track fitting 80 are no higher than the upper surfaces of the seat track.

d) A First Embodiment of the Invention

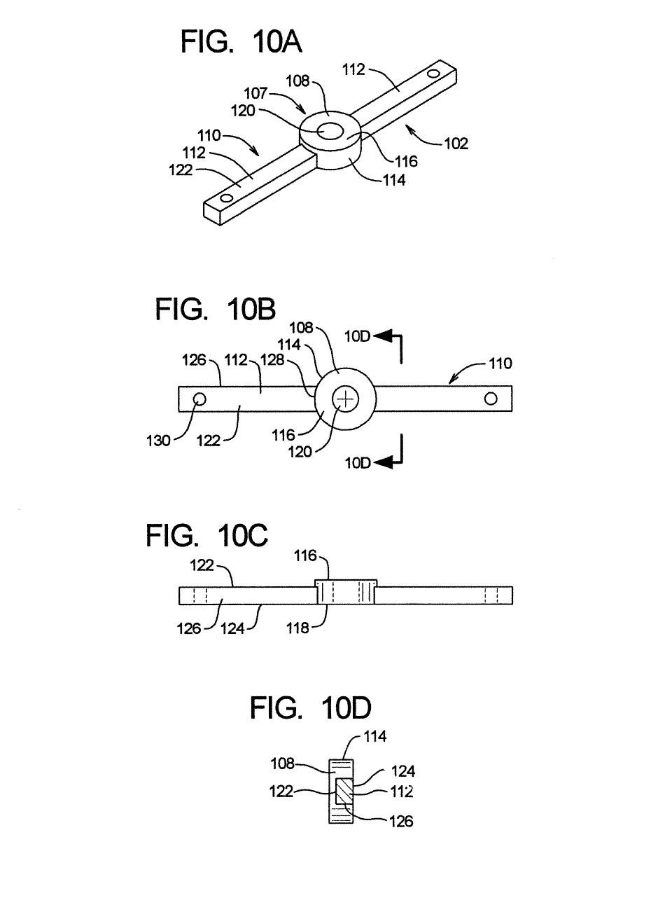

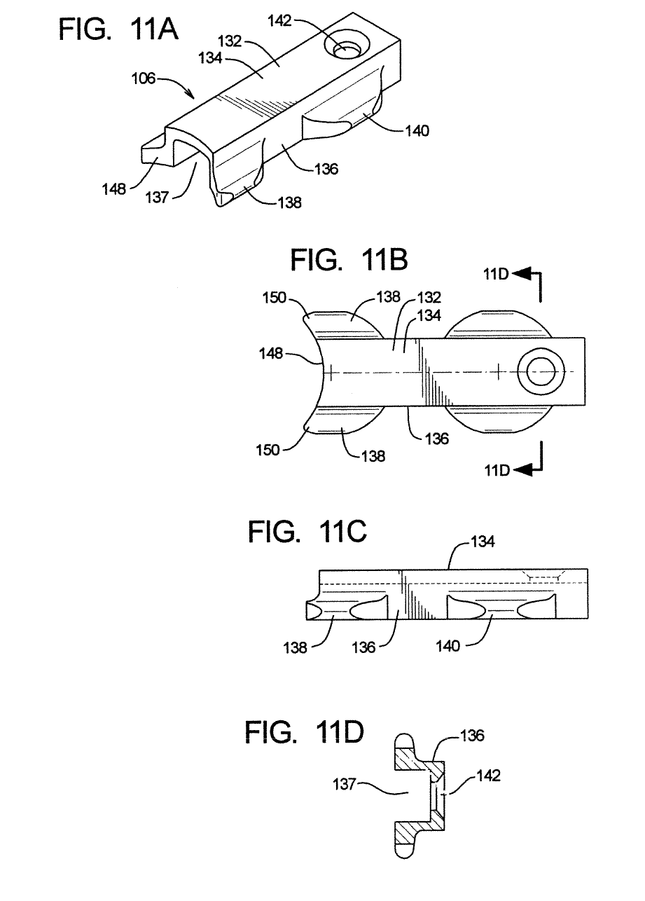

With the description of the seat track 10 and of the commonly used seat track attach fitting 80 having been completed, there will now be a description of a first embodiment of the present invention. The seat track attach assembly 100 of this first embodiment comprises a base section 102 (See FIGS. 10A-10D) and a retaining section 104 (See FIGS. 11A-11D). The retaining section 104 comprises two retaining components 106.

The base section 102 comprises a positioning section 107 comprising a positioning member 108 and a load reacting section 110. In this first embodiment, the load reacting section 110 comprises two load reacting members 112. The positioning member 108 has a disk-like configuration it has a perimeter surface 114 which in this embodiment is cylindrical. Further, there is an upper surface 116 and a lower surface 118, and a threaded cylindrical centrally located recess 120 which opens in an upward direction to the upper surface 116. Also, it is possible that in some instances this recess would not be centrally located.

Each of the load reacting members 112 has a generally rectangular configuration, with an upper surface 122, a lower surface 124, and two side surfaces 126. One end portion of each load reacting member connects with (or is made integrally with) the positioning member 108, and this location is indicated at 128 and is considered to be a load bearing connecting location relative to the positioning member 108. At the outer end of each load reacting member 112, there is at the upper surface a threaded recess 130 which enables the load reacting member 112 to connect to one of the aforementioned retaining components 106. These two load reacting members 112 are or may be identical.

As indicated previously, the retaining section 104 comprises two retaining components 106, and these components 106 are, or may be, identical. One of the two retaining components 106 is shown in FIGS. 11A-11D. Each retaining component 106 comprises a retaining structure 132 which has a generally inverted U-shaped configuration made up of three substantially planar walls, namely a top wall 134 and two side walls 136 which collectively define a retaining region 137. At the lower edge portions of the two side walls 136, there are two pairs of oppositely positioned retaining members, with a first pair of retaining members being designated 138 and the second being designated 140. The retaining members 138 and 140 extend laterally outwardly from the lower edges of the side walls 136, with each pair being spaced longitudinally from one another by spacing distance equal to the pitch distance of the pairs of lugs 56 on the seat track 10.

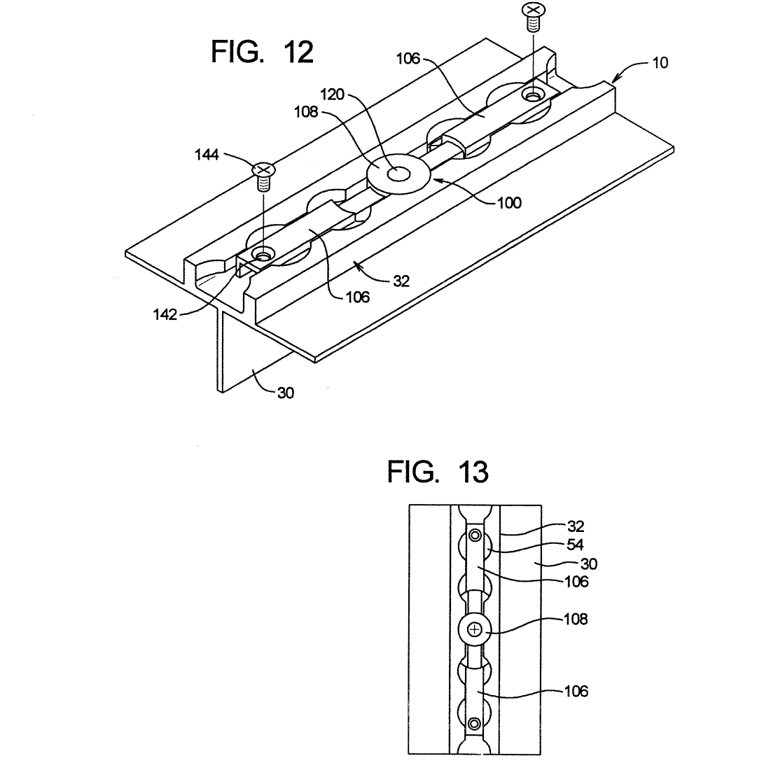

The top wall 134 has a countersunk opening 142 which is closer to the second pair of retaining members 140 and is positioned so that when the retaining member is in its retaining position, the opening 142 is aligned with the threaded recess 130 of its related load reacting member 112. Thus, a retaining screw 144 (See FIG. 12) can be inserted through the opening 142 and screwed into the recess 130 to hold the retaining component 106 in place relative to the base section 102. The transversely positioned end surface 148 of the retaining structure 132 and of the first retaining members 138 is formed as a circularly curved concave surface of the positioning member 108.

e) Method of the First Embodiment

To describe the manner in which the seat track attach fitting 100 is connected to the seat track 10, let us first discuss the manner in which each of the two main components (i.e. the base section 102) and the two retaining component 106 of the retaining section 104 are individually positioned in the seat track 10.

To place the base section 102 in the track, the first step is ascertain the particular positioning region 54 of the track 10 at which the connection of the connecting bolt 22 is to be made. When this is determined, the base section 102 is positioned so that the circularly shaped positioning member 108 is directly over the selected positioning region 54 with the two load reacting members 112 being aligned with (and centered on) the longitudinal axis 46. Then the base section 102 is lowered so that the positioning member 108 is positioned within the circular opening of the positioning region 54, and so that the two load reacting members 112 pass through the adjacent gaps or slots 58 defined by the adjacent lugs 56. In this position, the lower surfaces of both of the positioning member 108 and the load reacting members 112 are on the upper surface 38 of the floor 36. Also, the upper surface 116 of the positioning member 108 is flush with (i.e. at the same level as) the upper surface level 60 of the seat track 10. The upper surfaces 122 of the load reacting members 112 are below the upper surface level 60. Alternatively the upper surface 116 of the positioning member 108 may be higher than the upper surface level 60 of the seat track 10. Thus, these could be used in place of the prior art fittings that are not flush with the seat track without the use of a shim.

Then each of the retaining components 106 are positioned so that these are longitudinally aligned with the track and are at opposite ends of the base section 102 so as to be spaced a short distance away from the center location of the base section 102. This is done so that the laterally extending retaining members 138 and 140 are each aligned with an adjacent pair of the positioning regions 54. Then each retaining component 106 is lowered downwardly so that the retaining members 138 and 140 pass through the two aligned positioning regions 54 so that the lower surface areas of the two retaining component 106 are in contact with the upper surface 38 of the floor 36 of the channel 34 (See FIGS. 12 and 13).

It will be noted that in FIG. 12 there are shown the two retaining screws 144 aligned above the openings 130.

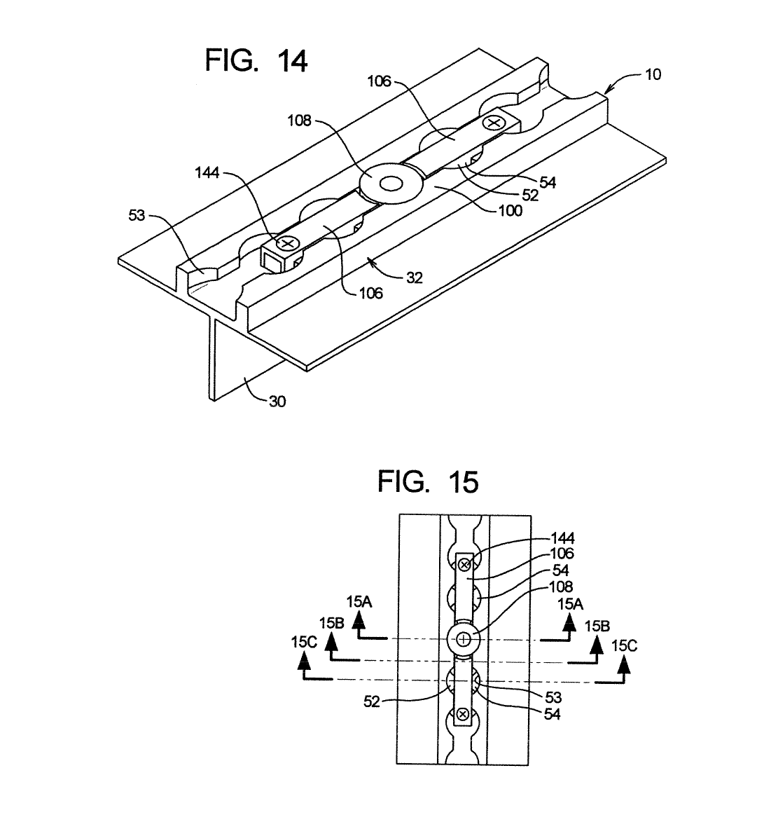

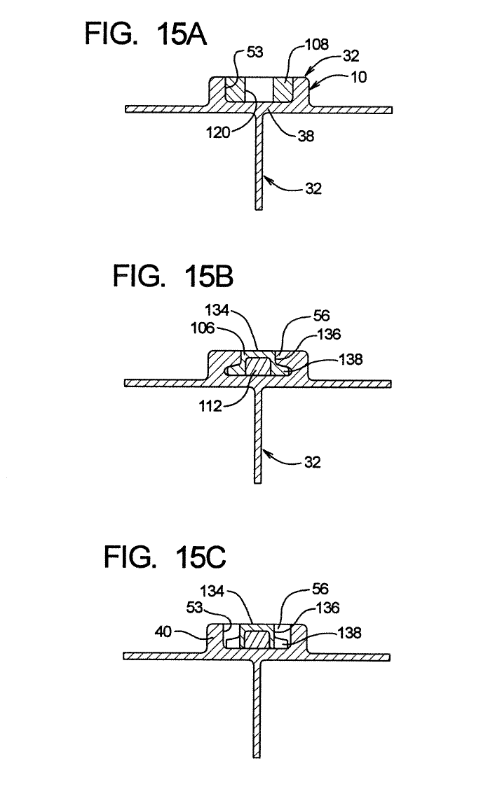

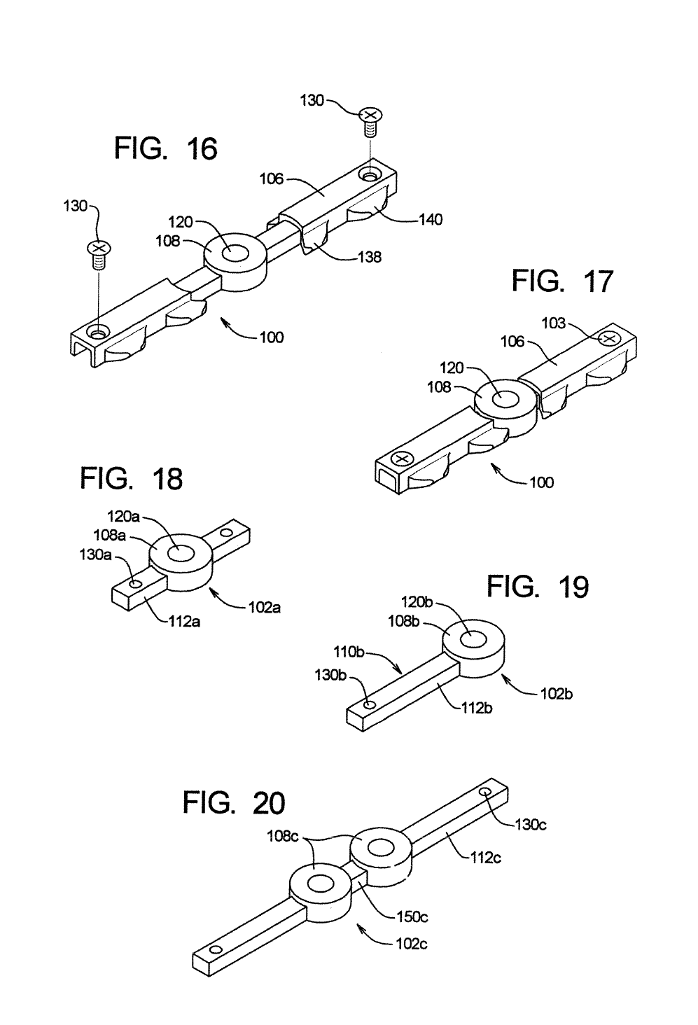

In that position each of the retaining components 106 can be moved in sliding motion through the channel 34 and along the longitudinal axis 46 of the track 10. The two retaining components 106 are moved toward the positioning member 108 until their end surface portions 148 come closely adjacent to the perimeter surface 114 of the positioning member 108 (See FIGS. 14 and 15, and also FIGS. 16 and 17). Thus the laterally outward portions 150 of the retaining members 138 have more surface area and underlying structure that is able to come into load bearing engagement with the lugs 56 of the track 10.

Then the retaining screws 144 are inserted through the openings 142 of the retaining components 106 and into the threaded recesses 130 of the two load reacting members 112. With this being accomplished, the object in the fuselage which is to be secured to the seat track attach fitting 100 is positioned so that its connecting bolt can be threaded into the upwardly facing central recess 120 of the positioning member 108.

Let us now examine the manner in which the various loads are imparted to the seat track attach fitting 100. The loads which would be transmitted into the fitting 100 are able to have vertical (up or down), lateral, and longitudinal (forward and rear) loads, and some loads will be combination of two or more of these load vectors (i.e. vertical, lateral, and longitudinal).

First, we start by recognizing that the loads that are imposed on the seat track attach fitting 100 result primarily from the loads imposed (either inertial loads or impact loads) on the object which is in turn attached to the seat track attach fitting 100 through the bolt that threads into the threaded recess opening 120 of the positioning member 108.

Let us first consider the lateral loads. The perimeter surface 114 of the positioning member 108 fits snuggly within the two inner edge surface portions 53 that define the positioning region 54. Thus, lateral loads that are imparted into the positioning member 108 are reacted into one or the other of the inner circular edge surfaces 53. Also, depending upon how close the tolerances are between the vertically aligned surface portions of the load reacting members 112 and the retaining components 106, lateral loads could also be reacted through these surfaces into the structure of the seat track 10.

With regard to longitudinally directed loads, these also are reacted from the positioning member 108 into the inner circular edge surfaces 53.

With regard to the vertical loads, these could result from a rather abrupt up or down movement of the airplane due to encountering turbulent atmospheric conditions. If there is a sudden upward acceleration of the aircraft, this would result in a downward inertial force that usually would be reacted from the object that is secured by the seat track attach fitting directly to the upper surface of the track 10, since the lower surface of the object itself usually rests directly on the upper surface of the track 10. Also, this could be reacted to some extent into the positioning member 108 and into the underlying floor surface 38. Further, these loads could be reacted also laterally outwardly into the load reacting members 1 12 and into the upper surface 38 of the floor 36 of the seat track 10.

With regard to an inertial force that results from the plane dropping rather abruptly downwardly, this inertial force would be directed upwardly into the positioning member 108 which in turn would react this vertically upward force into the two load reacting members 112 that would in turn react these into the top walls of the two retaining component 106. The load would then be reacted from each of the top walls 134 through the sidewalls 136 and into the retaining members 138 and 140 which would in turn react these loads into the lugs 56 of the seat track. This would result in the sheer loads and other loads associated therewith being imposed at the connecting region 128 and adjacent thereto between the positioning member 108 and each load reacting member 112.

If there is an abrupt decrease in the forward rate of travel of the aircraft. The object that is attached to the seat track attach fittings 100 would generally be attached by a more forward seat track attach fittings or fittings 100 and a more rearward fittings or fittings 100. The resulting forward inertial force would be translated into a force moment that would tend to impose an upward force on the rearward seat track attach fittings 100, as well as a forwardly directed force exerted against both of the rear and forward fittings 100, and a downward force on the upper surface of the track 10. Thus, these forces would be reacted in the same manner as the vertical force components and the forward force components.

f) A Second Embodiment of the Invention

A second embodiment of the present invention is shown in FIGS. 18, 21, and 24. Components of this second embodiment which are the same as, or similar to, those of the first embodiment will be given like numerical designations, with “a” suffix distinguishing those of the second embodiment.

In FIG. 18, there is shown the base section 102a comprising the positioning member 108a and the two load reacting members 112a. The threaded recess is shown at 130a. This base member 102a is substantially the same as the base member 102 of the first embodiment, except that the two load reacting members 112a are made shorter so these extend only below the lugs 56 which are immediately adjacent to the positioning member 108a.

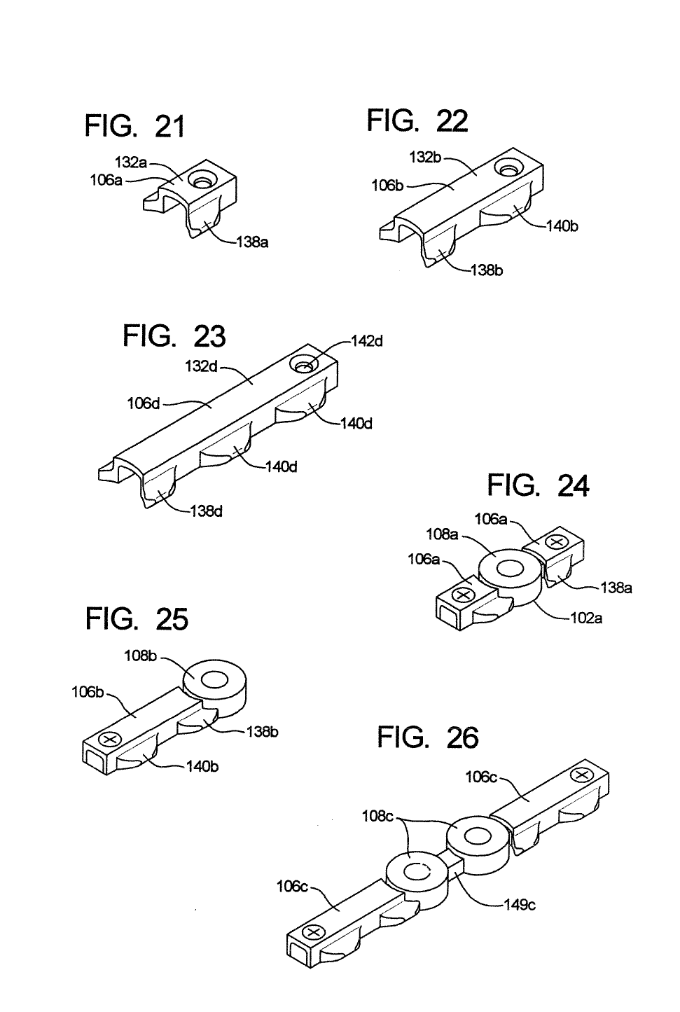

FIG. 21 shows one of the two retaining component 106a, comprising the retaining structure 132a and only the first pair of retaining members 138a. This retaining component 106a has approximately the same longitudinal length dimension as does the load reacting members 112a.

FIG. 24 shows the base section 102a and the two retaining components 106a in their assembled operating position in which these would be arranged when located in their secured position in the seat track 10. It is believed that the method of positioning the base member 102a and the retaining components 106a and how these react to loads is evident from the description of the mode of operation of the first embodiment. Accordingly, this will not be discussed further in this text.

g) A Third Embodiment of the Invention

A third embodiment of the present invention is shown in FIGS. 19, 22, and 25. Components of this third embodiment which are similar to components of the earlier embodiments will be given like numerical designations, with a “b” suffix distinguishing those of this third embodiment. This third embodiment is substantially the same as the first embodiment, except that the base section 102b has only one load reacting member 112b. Accordingly, there is required only one retaining component 106b. This retaining component 106b is (or may be) identical to the retaining component 106 of the first embodiment. These two components 102b and 106b are shown in their assembled position in FIG. 25. It is believed that the mode of operation of this third embodiment is evident from the prior descriptions of the mode of operation of the first and second embodiments.

h) A Fourth Embodiment of the Invention

A fourth embodiment of the present invention is shown in FIGS. 20 and 26. As was done in the description of the second and third embodiments, in describing this fourth embodiment, components which are the same as, or similar to, the components of the earlier embodiments will be given like numerical designations with a “c” suffix distinguishing those of the third embodiment.

In this fourth embodiment, the two retaining component 106c are the same as the retaining component 106 in the first embodiment and the third embodiment. Accordingly, that will not be described further herein.

This fourth embodiment differs from the earlier embodiments in that the base section 102c has two positioning members 108c that are connected to one another and are spaced from one another by one pitch distance of the track. Thus, there is an additional load reacting member 149c which has the same cross sectional configuration as the load reacting members 112c, and it is positioned between, and connects to, the two positioning members 108c. It is believed that the manner of installing this fourth embodiment in the track 10 and also the mode of operation of the second embodiment is evident from the earlier descriptions of the mode of operation of the embodiments so that there is no need for describing these in this text.

i) A Fifth Embodiment of the Invention

A fifth embodiment of the present invention is shown in FIG. 23. As in the descriptions of the prior embodiments, components which are similar to, or the same as, those of the earlier embodiments will be given like designations with a “d” suffix distinguishing those of this fifth embodiment.

To describe this fifth embodiment, there is shown in FIG. 23 only the retaining component 106d. This retaining component 106d differs from the retaining components 106, 106a, etc., in that it has a greater lengthwise dimension along the longitudinal axis and in addition to having the two pair retaining members 138d and 140d, there is yet a third pair of retaining members 140d. Accordingly, it is to be understood that the base section which is to be used with this retaining component 106d would have its load reacting member extended to a length that matches that of the retaining component 106d, so that the opening 142d would be aligned with a corresponding threaded opening in the related load reacting member of the fifth embodiment. In other respects, this fifth embodiment functions in substantially the same manner as the earlier embodiments, so there will not be any detailed description of the method of installing and the operating features of this fifth embodiment.

Also, features of several of the seat track attach fittings could be combined, such as having a shorter and longer load reacting members 112 in one base member. Other variations would be possible, depending on load requirements, space available, etc.

j) A Sixth Embodiment of the Present Invention

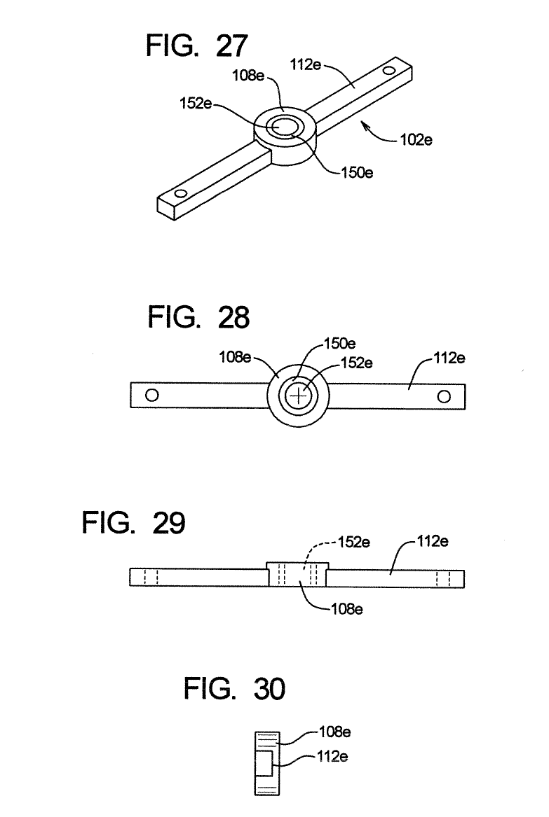

A sixth embodiment of the present invention will now be described with reference to FIGS. 27-30.

FIG. 27 is an isometric view of a base section 102e of this sixth embodiment. As in the prior embodiments, the base section 102e comprises a positioning member 108e with two load reacting members 112e. These load reacting members 112e are the same as in prior embodiments.

However, the positioning member 108e differs in that there is an insert provided in the positioning member 108e. This insert 150e has a cylindrical configuration with the center opening 152e. The insert 150 may be a threaded member having a thread lock arrangement to secure it into the opening 150e, and the interior of the insert 150e is able to receive the attaching member of a seat, cargo fitting, or other connecting member which is to be secured. The insert 150e may have interior threads.

In order respects, this sixth embodiment is similar to the first embodiment.

It is to be understood that various modifications could be made in the embodiments of the present invention without departing from the basic teachings thereof.

Therefore I claim:

1. A seat track assembly adapted to be used for securing articles and/or objects that are transported or to be transported or moved in an airplane or other transportation vehicle, where the articles and/or objects are secured to a seat track having a longitudinal axis, a transverse axis and a vertical axis, said seat track comprising a longitudinally extending channel, a plurality of longitudinally spaced access regions and a plurality of retaining regions located between adjacent pairs of said access regions, said assembly comprising:
a) a base section which is adapted to be connected to an object to be secured to the track and which comprises:
i. a positioning section comprising at least one positioning member which is arranged to be positioned in at least one of said access regions in an operation position of the base section;
ii. a load reacting section which comprises at least one load reacting member which is attached to said positioning member and is arranged to be positioned in said channel with said positioning section being in said operating position;
b) a retaining section comprising at least one retaining component which has a retaining portion and is arranged to be placed in said channel in an operating position, with said retaining component being moveable from a non-retaining position in said channel to a retaining position where the retaining portion of the retaining component is in retaining engagement with at least one of said retaining regions of the track, with said retaining component also being in retaining engagement with the load reacting section of the base section;
whereby the positioning member can be located in its operating position and said retaining member can be placed in said channel in its operating position and moved to its retaining position to retain the base section in its operating location.

2. The assembly as recited in claim 1, wherein said retaining portion of the retaining component is arranged with a configuration having a width dimension that is no greater than a width dimension of an access opening of the access region and arranged to enable the retaining portion to be moved into the access opening as the retaining member is moved into the channel, and the width dimension of the retaining portion of the retaining member being greater than a width dimension of an upper channel opening at the retaining region of the track.

3. The assembly as recited in claim 2, wherein there is a retaining device to retain said retaining member in its retaining position.

4. The assembly as recited in claim 2, wherein said positioning member has a side surface portion at least part of which is adjacent to and/or in engagement with a side surface portion of said access region of the seat track, in a manner that longitudinal and/or transverse force components on said positioning member are reacted into said seat track.

5. The assembly as recited in claim 1, wherein said positioning member has a side surface portion at least part of which is adjacent to and/or in engagement with a side surface portion of said access region of the seat track, in a manner that longitudinal and/or transverse force components on said positioning member are reacted into said seat track.

6. The assembly as recited in claim 1, wherein said retaining component has a lengthwise axis which, with said retaining component being positioned in the channel in its operating position, is parallel to the longitudinal axis, said retaining component comprising a top wall and two downwardly extending side walls, which in the operating position have the top wall adjacent to a top surface of the load reacting member and the side walls being adjacent to side surfaces of the load reacting member.

7. The assembly as recited in claim 6, wherein upper surfaces of said base section and said retaining section in their operating positions are no higher than an upper surface of said seat track.

8. The assembly as recited in claim 1, wherein an upper surface of said positioning section in its operating position is no greater than an upper surface of said seat track .

9. The assembly as recited in claim 1, wherein said positioning member has an access opening arranged to come into load bearing engagement with a connecting member of an object to be connected to said positioning member.

10. The assembly as recited in claim 1, wherein said positioning member is provided with an access opening which is arranged to receive a threaded connecting member which in turn is arranged to connect to a connecting member of an object to be secured to said assembly.

11. The assembly as recited in claim 1, wherein there are two load reacting members connected to, and extending oppositely from, said positioning member or members.

12. The assembly as recited in claim 1, wherein said positioning section comprises a plurality of connected positioning members.

13. The assembly as recited in claim 1, wherein:
a) the positioning section is arranged to be moved into the access region in the operating position in a manner that a side surface portion of the positioning section is in load bearing engagement with a surface portion of the access region;
b) said load reacting member is able to be moved through the retaining region of the track into the channel of the track into said operating position as said positioning section is being located into the access region;
c) the retaining portion of the load reacting member is arranged to be able to pass through an access region of the track as the load reacting member is being positioned into the channel in the operating position;
d) the retaining component in the operating position is arranged to be moved in the channel to said retaining position where the retaining component is in retaining engagement with the retaining region of the track.

14. The assembly as recited in claim 13, wherein the retaining portion of the retaining component comprises at least one pair of oppositely extending retaining members which are able to be positioned to be in load bearing engagement with a track retaining portion of the retaining region.

15. A system for securing articles and/or objects that are transported or to be transported or moved in an airplane or other transportation vehicle, said system comprising:
a) a seat track having a longitudinal axis, a transverse axis and a vertical axis, said seat track comprising a longitudinally extending channel, a plurality of longitudinally spaced access regions and a plurality of retaining regions located between adjacent pairs of said access regions;
b) a seat track assembly comprising a base section which is adapted to be connected to an object to be secured to the track and which comprises:
i. a positioning section comprising at least one positioning member which is arranged to be positioned in at least one of said access regions in an operation position of the base section;
ii. a load reacting section which comprises at least one load reacting member which is attached to said positioning member and is arranged to be positioned in said channel with said positioning section being in said operating position;
c) said seat track assembly further comprising a retaining section comprising at least one retaining component which has a retaining portion and is arranged to be placed in said channel in an operating position, with said retaining component being moveable from a non-retaining position in said channel to a retaining position where the retaining portion of the retaining component is in retaining engagement with at least one of said retaining regions of the track, with said retaining component also being in retaining engagement with the load reacting section of the base section;
whereby the base section can be located in its operating position in the channel and said retaining component can be placed in said channel in its operating position, and moved to its retaining position to retain the base section in its operating location.

16. The system as recited in claim 15, wherein said retaining component has a lengthwise axis which, with said retaining component being positioned in the channel in its operating position, is parallel to the longitudinal axis, said retaining component comprising a top wall and two downwardly extending side walls, which in the operating position have the top wall adjacent to a top surface of the load reacting member and the side walls being adjacent to side surfaces of the load reacting member.

17. The system as recited in claim 15, wherein:
a) the positioning section is arranged to be moved into the access region in the operating position in a manner that a side surface portion of the positioning section is in load bearing engagement with a surface portion of the access region;
b) said load reacting member is able to be moved through the retaining region of the track into the channel of the track into said operating position as said positioning section is being located into the access region;
c) the retaining portion of the load reacting member is arranged to be able to pass through an access region of the track as the load reacting member is being positioned into the channel in the operating position;
d) the retaining component in the operating position is arranged to be moved in the channel to said retaining position where the retaining component is in retaining engagement with the retaining region of the track.

18. A method for securing articles and/or objects that are transported or to be transported or moved in an airplane or other transportation vehicle, where the articles and/or objects are secured to a seat track having a longitudinal axis, a transverse axis and a vertical axis, said seat track comprising a longitudinally extending channel, a plurality of longitudinally spaced access regions and a plurality of retaining regions located between adjacent pairs of said access regions, said method comprising:
a) providing a base section which is adapted to be connected to an object to be secured to the track and which comprises:
i. a positioning section comprising at least one positioning member which is arranged to be positioned in at least one of said access regions in an operation position of the base section;
ii. a load reacting section which comprises at least one load reacting member which is attached to said positioning member and is arranged to be positioned in said channel with said positioning section being in said operating position;
b) providing a retaining section comprising at least one retaining component which has a retaining portion and is arranged to be placed in said channel in an operating position;
c) locating the positioning section in an operating position in the seat track, with the positioning member located in one of the access regions and the load reacting section located in the channel at one of the retaining regions;
d) positioning the retaining member in the channel of the track in a non-retaining position and moving the retaining member to a retaining position where the retaining portion of the retaining section is in retaining engagement with at least one of said retaining regions of the track, with said retaining component also being in retaining engagement with the load reacting section of the base section.

19. The method as recited in claim 18, wherein said retaining component has a lengthwise axis which, with said retaining component being positioned in the channel in its operating position, is parallel to the longitudinal axis, said retaining component comprising a top wall and two downwardly extending side walls, which in the operating position have the top wall adjacent to a top surface of the load reacting member and the side walls being adjacent to side surfaces of the load reacting member.

20. The method as recited in claim 1, wherein:
a) the positioning section is arranged to be moved into the access region in the operating position in a manner that a side surface portion of the positioning section is in load bearing engagement with a surface portion of the access region;
b) said load reacting member is able to be moved through the retaining region of the track into the channel of the track into said operating position as said positioning section is being located into the access region;
c) the retaining portion of the load reacting member is arranged to be able to pass through an access region of the track as the load reacting member is being positioned into the channel in the operating position;
d) the retaining component in the operating position is arranged to be moved in the channel to said retaining position where the retaining component is in retaining engagement with the retaining region of the track.
